(19) United States
(12) Patent Application Publication
(10) Pub. No.: US 2015/0222664 A1
(43) Pub. Date: Aug. 6, 2015

(54) CONFLICT RESOLUTION IN EXTENSION INDUCED MODIFICATIONS TO WEB REQUESTS AND WEB PAGE CONTENT

(71) Applicants: Dominic Battre, Munich (DE); Jochen Eisinger, Munich (DE); Bernhard Bauer, Munich (DE); Matthew Perry, San Francisco, CA (US); Erik Kay, Belmont, CA (US)

(72) Inventors: Dominic Battre, Munich (DE); Jochen Eisinger, Munich (DE); Bernhard Bauer, Munich (DE); Matthew Perry, San Francisco, CA (US); Erik Kay, Belmont, CA (US)

(73) Assignee: GOOGLE INC., Mountain View, CA (US)

(21) Appl. No.: 13/432,863

(22) Filed: Mar. 28, 2012

(51) Int. Cl. H04L 29/06; H04L 29/08

(52) U.S. Cl. CPC H04L 63/20; H04L 67/147

(57) ABSTRACT

A system includes an extension manager configured to cause at least one processor to execute multiple extensions in parallel that each attempt to modify a network request related to a webpage, and a conflict manager. The conflict manager is configured to cause the at least one processor to resolve conflicts among attempts by the multiple extensions to modify the network request. The conflicts are resolved using a set of precedence criteria and conflict rules. The conflict rules include for example logic that specifies that the network request is cancelled if any of the multiple extensions attempt to cancel the request. As another example, if at least two of the multiple extensions attempt to redirect the network request to at least two different URLs, the system determines which one extension is allowed to redirect the network request, and allows only the attempt by the one extension to redirect the network request.

### TECHNICAL FIELD

This disclosure generally relates to managing conflicts induced by web browser extensions trying to modify web requests and web pages.

### BACKGROUND

Web browsers enable users to interact with and experience many different types of content, usually over a computer network, and often in a visual or graphical manner. For example, users may install one or more Internet browsers on a local computing device, and may thereafter utilize the Internet browser to access content and/or functionality provided by a remote computing device.

Many browser applications provide a user with an ability to customize or personalize an appearance or functionality of the browser application in a manner desired by the user. In this way, the user may be more likely to enjoy, or benefit from, a use of the browser application. In particular, many browser applications support the use of discrete programs or files which are designed to provide a specific addition and/or alteration of one or more functionalities of an associated browser application. Such programs may be referred to using various, terminologies, such as, for example, extensions, add-ons, plug-ins, or web apps (or just apps).

As referenced above, such programs generally operate to provide some additional, specific functionality for a user's local browser application. For example, such programs may modify network requests (cancel requests, redirect requests, modify request headers, contribute authentication information) or cause an icon, image, or other content to be available within the context of the browser application, which would not normally be available to the user in that context. In such examples, such extension programs merely supplement already-present features and functionalities of the browser application.

In some cases, however, such extension programs may utilize a content script or other executable code which is designed to interact with content that is being remotely accessed by the browser application for loading and rendering thereof. For example, in the case where the browser application accesses a remote webpage over the Internet, such content script or other executable code associated with an extension program may be configured to interact with (e.g., read or make changes to) the webpage itself. Content scripts are JavaScript files that run in the context of web pages. By using a standard Document Object Model (DOM), content scripts can read details of a webpage that a web browser visits, or make changes to webpages. By registering event handlers, browser extensions can intercept network request and modify them.

Web browser extensions with content scripts often want to inject in every page that a user browses to, as a way of adding a general functionality to the browser. For example, browser extensions may apply a spellchecker, an address finder, or any generic functionality that could apply to any webpage.

In some cases, interactions between multiple browser extensions may conflict. For example, if multiple browser extensions attempt to redirect a request for a webpage to different targets, a conflict may arise.

### SUMMARY

According to one general aspect, a computer system includes instructions stored on a computer-readable medium and executable by at least one processor to execute a browser application and thereby provide a browser interface. The computer system includes an extension manager configured to cause at least one processor to execute multiple extensions in parallel that each attempt to modify a network request related to a webpage or the DOM tree of a webpage, and a conflict manager. The conflict manager is configured to cause the at least one processor to resolve conflicts among attempts by the multiple extensions to modify the network request or the DOM tree of a webpage. The conflicts are resolved using a set of precedence criteria and conflict resolution rules including logic that specifies how modification operations can be derived and merged.

According to another general aspect, a method includes executing, using a processor of a computing device, a browser application to provide a browser interface. Multiple extensions are executed in parallel that each attempt to modify a network request related to a webpage or the DOM tree of a webpage, and a conflict manager. Conflicts are resolved among attempts by the multiple extensions to modify the network request or the DOM tree of a webpage. The conflicts are resolved using a set of precedence criteria and conflict resolution rules including logic that specifies how modification operations can be derived and merged.

Other implementations are contemplated. For example, the set of precedence criteria may include an installation time of each of the multiple extensions, an alphanumerical order of a name of each of the multiple extensions, a priority attribute of each of the multiple extensions, or a user defined precedence order of extensions.

The details of one or more implementations are set forth in the accompanying drawings and the description below. Other features will be apparent from the description and drawings, and from the claims.

### BRIEF DESCRIPTION OF THE DRAWINGS

FIG. 1 is a flow diagram illustrating an example life cycle of a web request.

FIG. 2 is a block diagram illustrating an example system for managing conflicts among web requests.

FIG. 3 is a flowchart illustrating example operations of the system of FIG. 2, in an example context of allowing browser extensions to modify network requests and the page model of a webpage.

FIG. 4 is a block diagram showing example or representative computing devices and associated elements that may be used to implement the systems and methods of FIGS. 1-3.

### DETAILED DESCRIPTION

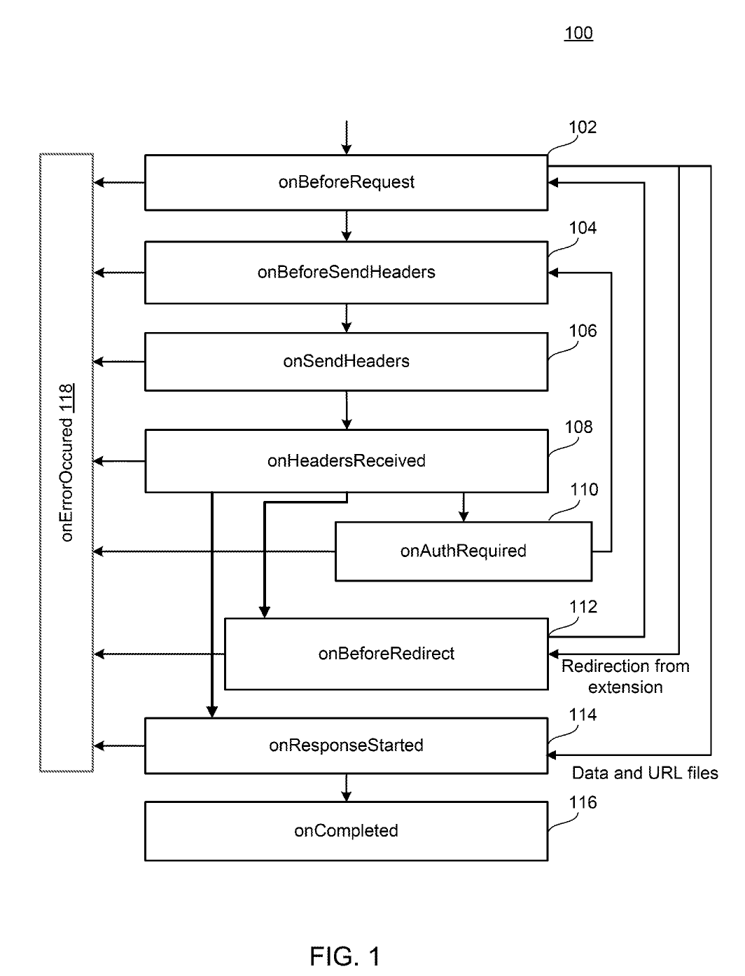

Browser extensions may attempt to intercept or block a web network request. Yet, interactions between multiple browser extensions, each attempting to intercept or block the request, may conflict. To understand how to manage conflicts among extensions, the life cycle of requests is explained in more detail below with respect to FIG. 1.

Life Cycle of Requests

FIG. 1 is a flow diagram of a life cycle of a web request. The events described with respect to FIG. 1 may be used to observe and analyze traffic. Certain synchronous events may allow extensions to intercept, block, or modify a request. In the example of FIG. 1, onBeforeRequest 102 is an optionally synchronous event that fires when a request is about to occur. An event is considered synchronous if event handlers block the further processing of the network request until they have returned information on how to continue processing this request. The onBeforeRequest 102 event may be sent before any TCP connection is made. This event may be used to cancel or redirect requests. If extensions redirect a URL request via an API, this redirection triggers an onBeforeRedirect 112 event next.

OnBeforeSendHeaders 104 is an optionally synchronous event that fires when a request is about to occur and the initial headers have been prepared. The event may allow extensions to add, modify, and delete request headers. The onBeforeSendHeaders 104 event may be passed to all subscribers, so different subscribers may attempt to modify the request in potentially conflicting ways. These conflicts need to be resolved. The onBeforeSendHeaders 104 event can be used to cancel the request.

The onSendHeaders 106 event may fire after all extensions have had a chance to modify the request headers, and presents the final version. The event may be triggered before the headers are sent to the network. This event is informational and handled asynchronously. It does not allow modifying or cancelling the request.

The onHeadersReceived 108 event is optionally synchronous and may fire each time that an HTTP(s) response header is received. Due to redirects and authentication requests this can happen multiple times per request. This event may allow extensions to add, modify, and delete response headers, such as incoming Set-Cookie headers.

The onAuthRequired 110 event is optionally synchronous and fires when a request requires authentication of the user. This event can be handled synchronously to provide authentication credentials.

The onBeforeRedirect 112 event fires when a redirect is about to be executed. A redirection can be triggered by an HTTP response code or by an extension. This event is informational and handled asynchronously. It does not allow extensions to modify or cancel the request.

The onResponseStarted 114 event fires when the first bytes of the response body have been received. For HTTP requests, this may mean that the status line and response headers are available. This event is informational and handled asynchronously. It does not allow modifying or cancelling the request.

The onCompleted 116 event fires when a request has been processed successfully. The onErrorOccurred 118 event fires when a request could not be processed successfully.

For each request, either onCompleted 116 or onErrorOccurred 118 may be fired as the final event to indicate to subscribers that no further events will be fired for the specific request.

Internally, one URL request can be split into several HTTP requests (for example to fetch individual byte ranges from a large file) or can be handled by a network stack without communicating with the network, e.g. if the request is answered from a cache or hard disk. In order to hide this complexity and prevent cache corruption, an API may not provide the actual HTTP headers that are sent to the network. For example, all headers that are related to caching may be invisible to the extension.

### Concepts

Events are labeled with the IDs of the requests they pertain to. Each request is identified by a request ID. This ID may be unique within a browser session and the context of an extension. It remains constant during the life cycle of a request and can be used to match different events associated with the same request. Several HTTP requests may be mapped to one web request to hide complexity from the extension, e.g., in the case of HTTP redirection or HTTP authentication.

To register an event listener for a web request signal, an addListener( ) function may be used. In addition to specifying a callback function, a filter argument may be specified and an optional extra info argument may be specified.

In one example implementation, the three arguments to the web request API's addListener( ) function may have the following definitions:

var callback = function(details) {...};
var filter = {...};
var opt_extraInfoSpec = [...];

An example of listening for the onBeforeRequest event includes:

chrome.webRequest.onBeforeRequest.addListener(
callback, filter, opt_extraInfoSpec);

Each addListener( ) function call may take a mandatory callback function as the first parameter. This callback function may be passed a dictionary containing information about the current URL request when called. The information in this dictionary may depend on the specific event type as well as the content of opt_extraInfoSpec.

If the optional opt_extraInfoSpec array contains for example the string ‘blocking’ (allowed for optionally synchronous events), the callback function may be handled synchronously. That means that the request may be blocked until the callback function returns. In this example, the callback can return a response that determines the further life cycle of the request. Depending on the context, this response allows cancelling or redirecting a request (onBeforeRequest), cancelling a request or modifying headers (onBeforeSendHeaders, onHeadersReceived), or providing authentication credentials (onAuthRequired).

The RequestFilter filter allows limiting the requests for which events are triggered in various dimensions, i.e., URLs, request types, tab IDs, and window IDs. URLs include URL patterns such as *://www.google.com/foo*bar. Request types include for example main frame requests (a document that is loaded for a top-level frame), sub frame requests (a document that is loaded for an embedded frame), and image requests (an image on a web site). A tab ID is the identifier for one tab. A window ID is the identifier for a window. Depending on the event type, a developer may specify strings in opt_extraInfoSpec to ask for additional information about the request. This is used to provide detailed information on a request's data if explicitly requested.

### Caching

Two caches may be used in the browser: an on-disk cache and a very fast in-memory cache. Requests that are answered from the in-memory cache may be invisible to the event listeners. This may be the case for browser implementations that chose to implement renderers (with in-memory cache) in a different operating system process, than the browser (with the on-disk cache). If a request handler changes its behavior (for example, the behavior according to which requests are blocked), a simple page refresh might not respect this changed behavior. To make sure the behavior change goes through, the in-memory cache may need to be flushed.

### Examples

The following example illustrates an implementation to block all requests to www.evil.com:

chrome.webRequest.onBeforeRequest.addListener(
function(details) {

return {cancel: details.url.indexOf(“://www.evil.com/”) != −1};

```
  },
  {urls: [“<all_urls>”]},
  [“blocking”]);
```

The following example achieves the same goal in a more efficient way because requests that are not targeted to www.evil.com do not need to be passed to the extension:

chrome.webRequest.onBeforeRequest.addListener(

function(details) { return {cancel: true}; },
{urls: [“*://www.evil.com/*”]},
[“blocking”]);

The following example illustrates how to delete the User-Agent header from all requests:

chrome.webRequest.onBeforeSendHeaders.addListener(
function(details) {

for (var i = 0; i < details.requestHeaders.length; ++i) {
if (details.requestHeaders[i].name === ‘User-Agent’) {

details.requestHeaders.splice(i, 1);
break;

}
}
return {requestHeaders: details.requestHeaders};

```
  },
  {urls: [“<all_urls>”]},
  [“blocking”, “requestHeaders”]);
```

### Events

It is possible to subscribe to events such as onAuthRequired 110 by calling an addListener( ) function of the event. This function may take three arguments, a callback function that is called if the event is triggered, a filter to limit in which cases the callback function is called, and an extra info specification that indicates if additional details about the request shall be passed to the callback. The additional details may be large, and therefore, may only be provided upon request.

The callback function is informed about the event that is happening for a specific request. It receives information about the request such as the following:

requestId—The ID of the request. Request IDs may be unique within a browser session. As a result, they may be used to relate different events of the same request.

url—Target of the request

method—HTTP request method

frameId—Identifier for the frame in which the request happens

parentFrameId—Identifier of the frame that wraps the frame in which the request happens

tabId—Identifier of the tab in which the request happens

windowId—Identifier of the window in which the request happens

type—Type of the request (request for the content for a main frame, a sub frame, stylesheet, script, image, object, xml http request, etc.)

time stamp—When the event was triggered

authentication information—Information that indicates what kind of credentials are expected (HTTP authentication scheme, realm, challenger)

connection information—hostname, IP, port number of the server, serving the request

request and response headers

whether a request is answered from the cache

redirection information—whether a request is being redirected

The callback function may return instructions to cancel a request, to redirect it to a new URL, to substitute request or response headers or to pass authentication credentials to a request. The callback function may pass this as a return value or by calling another callback function.

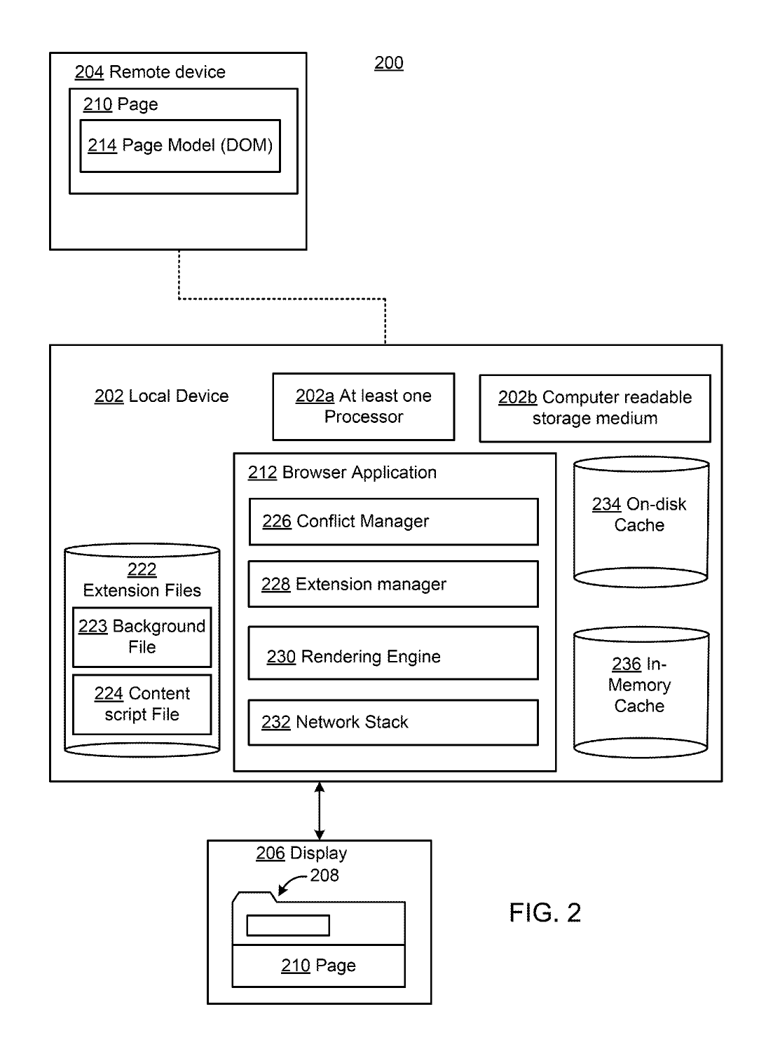

FIG. 2 is a block diagram of a system 200 for managing conflicts among extensions modifying web requests or the DOM tree of websites. In the example of FIG. 2, a local computing device 202 is illustrated as communicating with a remote computing device 204 in order to provide, using a display 206, a browser window 208 which contains a page 210 that is stored at the remote device 204. Remote device 204 may be a computing device such as a server, for example.

A local device 202 may generally represent virtually any computing device which may be configured to execute browser application 212, and to communicate with the remote device 204. For example, the local device 202 may include any standard desktop or personal computing device, any laptop, notebook, or netbook computer, any tablet computer, or any Smartphone or other mobile computing device. Such computing devices, and other computing devices, may be configured to access the remote device 204 over one or more computer networks, in any conventional manner. For example, many local devices 202 may include various types of network-related hardware/software which enable the local device 202 to communicate over the public Internet, private intranet, or other network, to thereby access the remote device 204. Consequently, the display 206 may be understood to represent virtually any conventional type of display, e.g., monitor, touch-screen, or any other type of visual or auditory display.

In the examples that follow, it is generally assumed that the local device 202 and the browser application 212 communicate with the remote device 204 over the public Internet, therefore typically using standard and conventional protocols for identifying, accessing, and rendering the page 210, e.g., from a web server represented by the remote device 204. However, it will be appreciated that such examples are provided merely for the sake of clarity and conciseness, and, as just referenced above, are not intended to be limiting of the various manners in which the local device 202 may obtain, process, or provide content in association with the browser application 212 and the browser window 208.

Thus, in the types of examples just referenced, it may generally be assumed that the page 210 represents any of the many types of webpages which are available over the public Internet. For example, in a simple scenario, the page 210 may represent a substantially static page which includes text, sound, images, or other content which may be desired by a user of the system 200 and which may be displayed within the browser window 208. In other examples, the page 210 may include many types of dynamic or interactive content, which often may be manipulated by the user within the context of the browser window 208. In many scenarios, the page 210 and/or associated executable code may be understood to represent an application which may execute partially or completely at the remote device 204 (e.g., may utilize the processor, memory, and other hardware/software resources of the remote device 204), while providing associated functionality and features to the user via the browser window 208 (and perhaps executing at least partially locally at the local device 202). As just referenced, such webpages and associated functionalities and applications are implementable using various, conventional programming languages and techniques, such as, for example, hypertext markup language (HTML), Asynchronous JavaScript (AJAX), eXtensible Markup Language (XML), JavaScript, JavaScript object notation (JSON), and many other types of code which may be executed.

In the example of FIG. 2, the page 210 at the remote device 204 is illustrated as including, or being associated with, a page model 214. Generally speaking, the page model 214 provides a data structure which defines the structure, content, and appearance of the page 210 with respect to a programming language in which the page 210 is written.

In specific examples described herein, the page model 214 may represent a document object model (DOM) data structure. Such a DOM, as just referenced, represents a data structure (typically, a tree-like data structure) that itself represents HTML of the page 210.

As described herein, browser extensions may be utilized in the system 200 to provide additional features or functionalities in association with the browser application 212, and thus with respect to the browser window 208. The functionality of extensions may include but are not limited to observing and modifying network traffic and modifying the page model 214 of the page 210. Other functionality may include interacting with the user, and adding buttons and other user interface elements to the browser and handling their interaction with the user.

As may be understood from the above description, extensions defined by the extension files 222 may generally refer to browser extensions, add-ons, plug-ins, web applications (web apps, apps) or any other program code which is designed to augment an appearance or functionality of the browser application 212 in providing the browser window 208 and/or the example page 210. Extension files 222 may in particular perform modifications to network requests related to web page 210, such as canceling requests for individual resources, redirecting the request for web page 210 or referenced resources, modifying request and response headers of web requests related to web page 210, or contributing authentication information to retrieve web page 210. For example, extensions redirect a user who has requested a link of www.badlink.com to www.goodlink.com.

In the simplified example of the system 200 of FIG. 2, the extension files 222 are illustrated as being stored locally to the local computing device 202. For example, a user of the local computing device 202 may program and store the extension files 222 for use by the browser application 212. In additional or alternative examples, however, it may be appreciated that some or all of the extension files 222 may be accessed remotely. For example, in many cases, a particular extension may be packaged within a single folder or archive which may then be accessed by the browser application 212. For example, a provider and/or distributor of the extension files 222 (not specifically illustrated in the example of FIG. 2) may construct and package the extension files 222, and a user of the system 200 may thereby download and install a desired extension, including accessing, downloading, and installing the extension files 222 at the local computing device 202, as shown.

The browser application 212 may include a rendering engine 230 that is used to convert the page model 214 of a page 210 into information that can be displayed to the user in browser window 208.

The browser application 212 may include a network stack 232 that is used to retrieve pages 210 from remote devices 204 over a network, from the local device 202, or from other sources in order to be processed by the rendering engine 230. A network request shall herein represent an act of communication to retrieve the contents of a resource. It may be answered by remote devices 204, storage of the local device 202, caches 234 and 236, and other embodiments. A reader familiar with the art will appreciate that the network stack may be implemented partially or completely in the browser application 212 or the operating system of local device 202.

The network stack 232 may be responsible for firing events according to the life cycle described in FIG. 1.

The network stack 232 and the rendering engine 230 may employ in-memory caches 236 as well as on-disk caches 234 to accelerate the retrieval and rendering of pages 210. The caches may be managed by the browser application 212 or by the operating system of local device 202. The caches may be located on remote devices 204. Caches may simulate the behavior of a remote device 204 or be accessed directly.

The extension manager 228 may be responsible for installing, loading and executing extensions. It may be responsible for handling communication between the extensions 222, the network stack 232, the rendering engine 230, and the conflict manager 226. As such it may dispatch the events generated by network stack 232 to all subscribed extensions 222, collect their desired modifications to web requests, send them to the conflict manager 226 and send the results back to the network stack. Parts or all of this functionality may be executed by other components or the browser application 212.

The conflict manager 226 may be responsible for detecting and resolving conflicts of extensions that try to modify web requests or the page model 214.

Of course, it may be appreciated that the browser application 212 may include, or be associated with, various features, functions, operational modules, or other elements which are not specifically illustrated in the context of FIG. 2. Similarly, it may be appreciated that the terminology used in association with the rendering engine 230 and the extension manager 228 is merely for the sake of example, and that the various types of browser applications 212 which exist, or which may exist in the future, may use different terminology when referring to the various concepts described herein.

As referenced above, the extension files 222 may include various different types of files. For example, the extension files 222 may include a manifest file which gives information about the extension, such as, for example, the most important files and the capabilities that the extension might provide and the permissions the extension may have to interact with pages 210 and the browser application 212. In another example, as illustrated in the example of FIG. 2, the extension files 222 may include a background file 223 or background page which may generally represent an invisible page which holds the main logic of the extension, and which may thus run in the background so as to be always available in case of some initiation of a relevant extension action. For example, for an extension installed on the local device 202 which includes the extension files 222, a background page may register event listeners that are notified in case events are triggered. It may be appreciated that, as referenced above, the extension files 222 may include various other types of files. For example, the extension files 222 may include other types of HTML pages, such as, for example, an HTML page associated with a browser action providing a pop-up window in association with the browser window 208 or a content script file 224 that is capable of modifying the content of a page model 214.

Since the extension files may include web pages, the extension files 222, e.g., the background page, may execute in their own rendering process, analogous to the rendering engine 230. More specifically, with respect to the execution of the extension files 222, other than the content script 224 as described below, execution thereof may proceed similarly to, but in a separate process than that of, the rendering engine 230 of the browser application 212. As illustrated in the example of FIG. 2, the extension files 222 may include, or be associated with, a content script 224. The content script file 224 may represent, or include, a content script which enables an associated extension to interact with webpages, e.g., the page 210. For example, the content script of the content script file 224 may be implemented as JavaScript that executes in the context of the page 210 as loaded into the browser application 212.

Content scripts can find unlinked URLs in web pages and convert them into hyperlinks, increase font size to make text more legible, and find and process microformat data in the DOM 214. Content scripts can indirectly use browser APIs, get access to extension data, and request extension actions by exchanging messages with their parent extension. Content scripts can also make cross-site XMLHttpRequests to the same sites as their parent extensions, and they can communicate with web pages using the DOM 214.

The content script 224 code may always be injected in a website, or may only sometimes be injected depending upon how the content script is written. Further, an extension 222 can insert multiple content scripts into a page, and each of these content scripts may have multiple JavaScript and CSS files.

Content scripts, generally speaking, may be configured to, for example, read details of webpages visited by the browser application 212, and may be further configured to make changes to such pages. For example, as described in detail herein, the content script may be configured to read and/or modify the page model (e.g., DOM) 214 of the page 210. In example implementations, however, the content script may be restricted from accessing or modifying the page model (e.g., DOM) of the background page of the background file 223 associated with the parent extension of the content script 224 (e.g., as part of the multi-process architecture described herein).

Nonetheless, the content script 224 may be enabled to communicate with the background page of the relevant parent extension, or with other files/pages associated with the parent extension. For example, the content script may be enabled to exchange messages with its parent extension. The content script might send such messages to the background page in response to some detected event, so as to thereby trigger a browser action or page action on the part of the background page. Additionally, the background page may be enabled to send a message to the content script, e.g., to request the content script to change the appearance of the relevant browser page, (e.g., the page 210) in a desired manner.

As also shown in the example of FIG. 2, the browser application 212 may include an extension manager 228 which may be configured to implement some or all of the functionality of a particular extension, such as an extension associated with the extension files 222. For example, the extension manager 228 may be configured to cause the rendering engine 230 to execute or otherwise render particular files or pages associated with the extension of the extension files 222. It may be configured to execute background pages and content scripts.

The browser application 212 may also include or be associated with a conflict manager 226 which may be configured to evaluate the extension file(s) 222 and any conflicting attempts the extensions to modify the page 210.

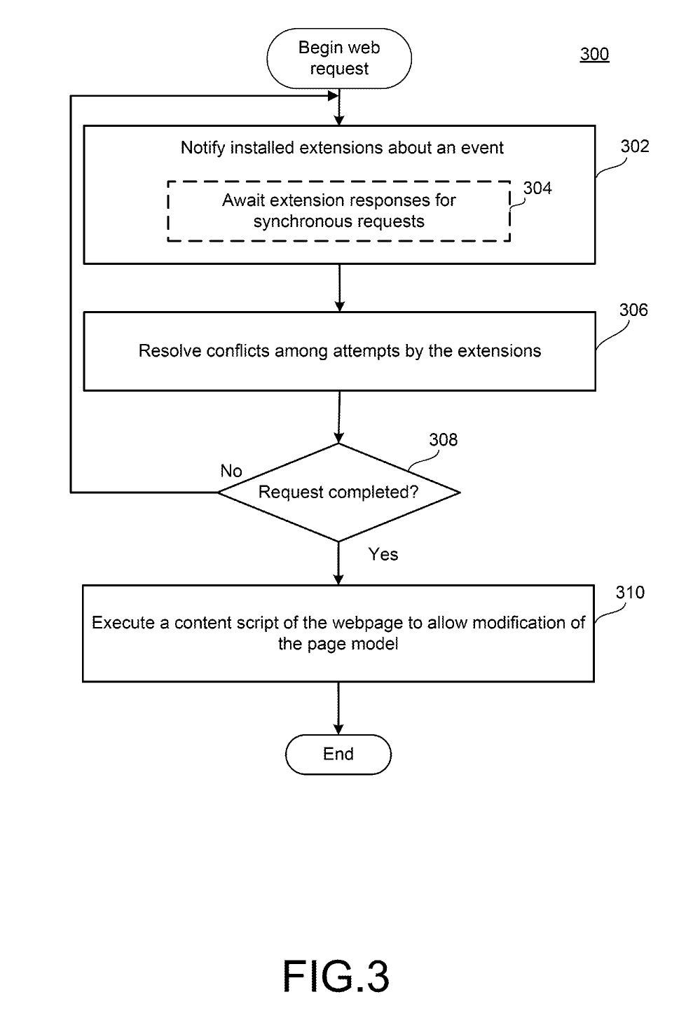

To resolve conflicts among extensions, conflict manager 226 may utilize precedence criteria, as described in more detail below with respect to FIG. 3, and/or conflict analysis logic to determine which extension's action should take priority. As one example, conflict manager may utilize conflict analysis logic to determine which extension was installed first, and give priority to the actions of that first-installed extension. In some implementations conflict analysis logic may be stored at local device 202, while in other implementations, conflict analysis logic may be stored at remote device 204. In some implementations, multiple extensions may execute sequentially in a particular order as determined by conflict analysis logic or precedence criteria, as described in more detail below with respect to FIG. 3.

In some implementations, conflict analysis logic may be used by conflict manager 226 to consider a request as canceled if at least one extension instructs to cancel the request. If an extension cancels a request, all extensions may be notified by an onErrorOccurred event, as described in more detail below. In some implementations, only one extension may be allowed to redirect a request or modify a header at a time. In those implementations, if more than one extension attempts to modify the request, the most recently installed extension may win while all others may be ignored. In some implementations, an extension is not notified if its instruction to modify or redirect has been ignored. The conflict manager is not limited to resolving the conflicts listed as examples above.

In some implementations, users may override decisions or logic used by conflict manager 226, for example to allow multiple extensions to modify a specific web page in a specific way.

In the example of FIG. 2, the browser application 212 is illustrated including discrete functional modules. However, it may be appreciated that such illustration is merely for the sake of example, and that other implementations are possible. For example, a single element of the browser application 212 may be implemented by two or more elements. Conversely, two or more components of the browser application illustrated in FIG. 2 may be executed using a single component. For example extension manager 228 and conflict manager 226 may be executed using a single component.

Further, in the example of FIG. 2, the local device 202 is illustrated as including at least one processor 202a, as well as computer readable storage medium 202b. That is, for example, the local computing device 202 may rely on two or more processors executing in parallel to achieve a desired result. Meanwhile, the compute readable storage medium 202b may represent any conventional type of computer memory which may be used, for example, to store instructions which, when executed by the at least one processor 202a, cause the browser application 212 to perform various functions, and other relevant functions described herein. Additional or alternative example implementations of the system 200 of FIG. 2 are possible.

Events

FIG. 3 is a flowchart 300 illustrating how the browser notifies extensions about life cycle events of a web request and resolves conflicts of modifications requests to the web request. In the example of FIG. 3, a user may request a webpage, such as “http://www.example.com/” and the figure illustrates the life cycle of a single web request related to this webpage, e.g. for fetching the “http://www.example.com/index.html” page. Multiple web requests may be processed in parallel and interleaved. Each web request passes the automaton illustrated in FIG. 3.

System 200, for example using browser application 212, may notify (some or all) event handlers of installed extensions (e.g., extension files 222) about the individual stages of the life cycle of a web request. Each stage triggers an event (e.g., one of the events described above with respect to FIG. 1, such as onBeforeRequest 102), (302), that may be processed by all event listeners in parallel. Browser application 212 may await extension responses for synchronous event listeners (304) before proceeding in the life cycle of the web request.

Different modifications can be performed on web requests, including, for example: cancelling the request, redirecting the request to a new URL, modifying request headers, modifying response headers, or adding authentication credentials.

Different browser extensions may try to perform these modifications on the same request in parallel. Browser application 212, for example using conflict manager 226, may resolve conflicts among attempts by the extensions to modify a network request (306). Details are presented below.

The conflict manager 226 may, in some implementations, allow only one of the multiple extensions at a time to modify a web request. The extension may be determined by precedence criteria such as the installation time of extensions.

The conflict manager 226 may, in some implementations, allow multiple extensions at a time to modify a web request. For this it is may merge modifications of events received from the event handlers. Conflicts may be resolved as described below, or, in some implementations, conflicts may be ignored and flagged to the user (e.g., with a pop-up warning message or other notification). The decision, which modifications need to be ignored in case of conflicts, may be cased on precedence criteria among the extensions.

At block 308, if the request is not completed (308, no), the process returns to block 302. This reflects the multiple phases of the life cycle of a request. If the request is completed (308, yes), browser application 212 may execute a content script (e.g., content script 224) on the webpage to allow modifying the page model 214.

Conflicts can be resolved in different ways based on precedences among the extensions. The precedence of extensions may be defined by the order in which extensions were installed, by an alphanumerical sorting of the extensions' names, by assigned priorities, by an order defined by the user, and in other ways.

For example, in some implementations, an extension may only override modifications of extensions of lower precedence. In some implementations, an extension may only perform modifications if no extension of higher precedence has performed modifications.

The precedence may be used for ordering all extensions and letting one extension after another modify the request or page model. In such an implementation, the extensions may be executed one after another.

Conflict Resolution Options

In some implementations, a request is considered as canceled if at least one extension decides to cancel the request. Alternatively or additionally, if at least one extension decides to cancel the request while another extension decides to redirect the request, the cancel operation takes precedence.

Other options for conflict resolution include having a cancel operation extended to a “Cancel and redirect” operation, for example to redirect a request for an image to a different, transparent image. In this case, “Cancel and redirect” may take precedence over other redirects, while “Cancel” takes precedence over “Cancel and redirect”. The redirect target may be a data://URL that encodes a transparent image. If two or more “Cancel and redirect” operations redirect to the same destination, they may be considered compatible. If the redirect destinations differ, the operations are in conflict. In that case, the extension with the highest precedence wins and the conflicting extensions are flagged to the user.

Two or more redirect requests by two or more extensions that redirect to the same destination may be considered compatible. Two or more redirect requests by two or more extensions that redirect to different destinations may be considered incompatible and in conflict. In that case, the extension with the highest precedence wins and the conflicting extensions may be flagged to the user.

HTTP request and response headers consist of a name and a value. HTTP requests often contain headers with unique names (each header name occurs at most once in a request), whereas HTTP responses often contain duplicate header names (e.g., a Set-Cookie header). Therefore, conflict resolution for modifying request headers and response headers may differ.

To merge the request header modification of several extensions, the first step is to calculate a delta between the original request headers and the modified request headers. This delta may be expressed in two edit operations: “delete request header” and “modify request header.”

Formally, this may be expressed as:

```
Header(name, value) ∈ DeleteRequestHeaders [symbol]
  Header(name, value) ∈ OriginalRequestHeaders [symbol] [symbol]
  ∃ value’ : Header(name, value’) ∈ NewRequestHeaders
Header(name, value) ∈ ModifyRequestHeaders [symbol]
  Header(name, value) ∈ NewRequestHeaders [symbol]
  Header(name, value) ∉ OriginalRequestHeaders,
or equivalent
ModifyRequestHeaders = NewRequestHeaders \ OriginalRequestHeaders
```

This is illustrated in the following example, as shown in Table A and Table B.

TABLE A
Original Request Headers

| | |
|---|---|
| Header1: | Value1 |
| Header2: | Value2 |
| Header3: | Value3 |

TABLE B
New request headers

| | |
|---|---|
| Header1: | Value1 |
| Header2: | Value3 |
| Header4: | Value4 |

The delta of this modification is: Delete “Header3”, Modify “Header2” to “Value3”, Modify “Header4” to “Value4” or formally:

DeleteRequestHeaders = { Header(“Header3”, “Value3”) }
ModifyRequestHeaders = { Header(“Header2”, “Value3”),
Header(“Header4”, “Value4”) }

Two or more request header modifications may be in conflict if two or more extensions contain headers in the union of DeleteHeaders and ModifyHeaders with the same name but different values. In this case, the edit operation of the extension with higher precedence wins and the conflicting extensions may be flagged to the user.

In order to perform the modification, the browser may iterate over all extensions in the order of precedence of the extensions. If an extension E is in conflict with previously visited extensions, all modifications of E are ignored and the extension is flagged to the user. Otherwise, all deletion and modification operations of E are executed on the request headers.

In another implementation, the browser may iterate over all extensions in the order of precedence of the extensions. If an extension E is in conflict with previously visited extensions, only the conflicting modifications of E are ignored and the extension is flagged to the user. Otherwise, all deletion and modification operations of E are executed on the request headers.

In another implementation the flagging of extensions is omitted.

To merge the response headers of several extensions, the first step is to calculate a delta between the original response headers and the new response headers. This delta is expressed in “added response header” and “deleted response header” operations. Formally, this delta may be expressed as:

```
Header(name, value) ∈ DeleteResponseHeaders [symbol]
  Header(name, value) ∈ OriginalResponseHeaders [symbol]
  Header(name, value) ∉ NewResponseHeaders,
or equivalent
DeleteResponseHeaders = OriginalResponseHeaders \
NewResponseHeaders
Header(name, value) ∈ AddResponseHeaders [symbol]
  Header(name, value) ∈ NewResponseHeaders [symbol]
  Header(name, value) ∉ OriginalResponseHeaders,
or equivalent
AddResponseHeaders = NewReponseHeaders \ OriginalResponseHeaders.
```

This is illustrated in the following example:

TABLE C
Original Response Headers

| | |
|---|---|
| Header1: | Value1 |
| Header1: | Value2 |
| Header2: | Value3 |

TABLE D
New Response Headers

| | |
|---|---|
| Header1: | Value1 |
| Header2: | Value4 |
| Header3: | Value5 |

DeleteResponseHeaders = { Header(“Header1”, “Value2”),
Header(“Header2”, “Value3”) }
AddResponseHeaders = { Header(“Header2”, “Value4”),
Header(“Header3”, “Value5”) }

Two or more response header modifications are in conflict if two or more extensions delete the same header. This assumption is based on the idea that the extensions deleted the header in order to replace it by different values.

After calculating the delete and add operations, conflict resolution may be performed analogously to the conflict resolution for request headers.

If two or more extensions set different authentication credentials, the conflict resolution can be executed by either trying each set of the credentials in turn, or by flagging all conflicting extensions and using the credentials of the extension with the highest precedence.

### Conflict Resolution for Multiple Extensions Attempting to Modify Website Content

Conflict resolution as described with respect to FIGS. 1-3 may also apply not only to resolution of conflicts for extensions attempting to modify web network requests. For example, conflicts among extensions attempting to modify the content of a website (e.g., a font color, font size, etc.) can be expressed as edit operations. To resolve conflicts, an order may be established in which edit operations are executed. For each edit operation, a rule may exist according to which edit operations can be merged or flagged as conflicting.

In another implementation, edit operations on the content of a website may be performed by executing the extensions sequentially.

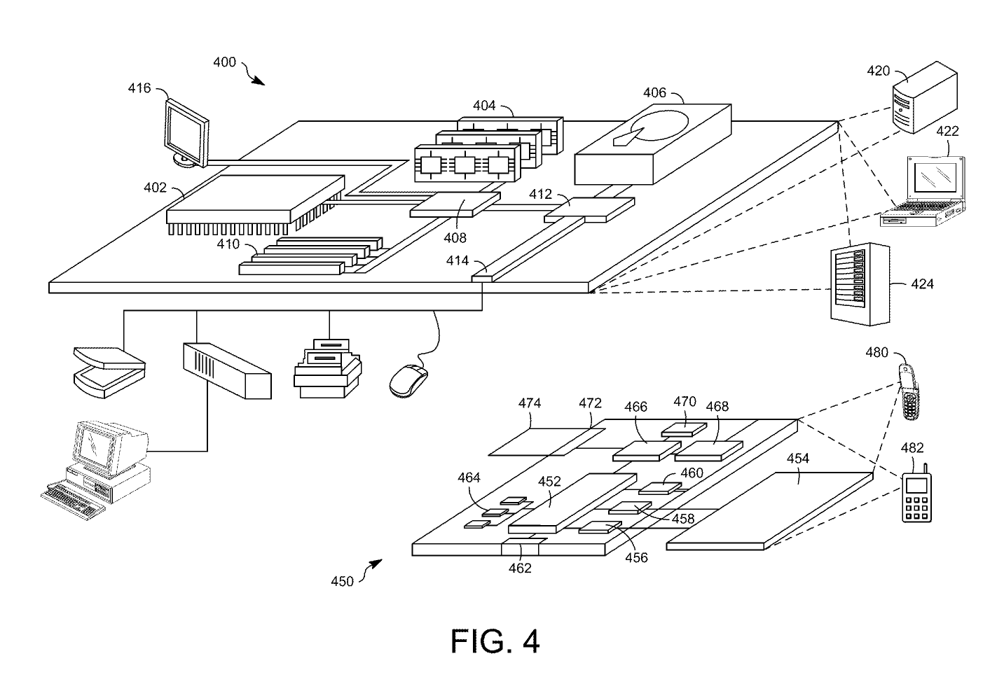

FIG. 4 shows an example of a generic computer device 400 and a generic mobile computer device 450, which may be used with the techniques described here. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smart phones, and other similar computing devices. The components shown here, their connections and relationships, and their functions, are meant to be exemplary only, and are not meant to limit implementations described in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of functions is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452, that may be received, for example, over transceiver 468 or external interface 462.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDM22000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning system) receiver module 470 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smart phone 482, personal digital assistant, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

1. A computer system including instructions stored on a computer-readable medium and executable by one processor to execute a browser application and thereby provide a browser interface, the computer system comprising:
an extension manager configured to cause the at least one processor to execute multiple extensions in parallel that each attempt to modify a network request related to a webpage; and
a conflict manager configured to cause the at least one processor to analyze attempted modifications of the network request and resolve conflicts among the attempted modifications of the network request, wherein the conflicts are resolved using a set of precedence criteria and rules that specify how conflicts are resolved.

2. The system of claim 1, wherein the extension manager allows the extensions to modify a network request before a TCP connection to the server is opened.

3. The system of claim 1, wherein the extension manager allows the extensions to modify a network request before the network request is sent to a server.

4. The system of claim 1, wherein the extension manager allows the multiple extensions to modify a response of a server before the response is processed further by the browser application.

5. The system of claim 1, where modifying the network request includes cancelling the network request.

6. The system of claim 1, where modifying the network request includes redirecting the network request.

7. The system of claim 1, where modifying the network request includes modifying request headers.

8. The system of claim 1, where modifying the network request includes modifying response headers.

9. The system of claim 1, where modifying the network request includes providing authentication credentials.

10. The system of claim 1, wherein analyzing the modification consists of comparing an old attribute of the network request with a modified attribute of the network request, and considering a delta representing the comparison, for further processing.

11. The system of claim 1, where extensions modify requests by sending deltas in a form of edit operations themselves.

12. The system of claim 1, where conflicts are resolved by analyzing precedences of extensions.

13. The system of claim 12, where the precedences of extensions are defined by a time that each of the multiple extensions were installed.

14. The system of claim 12, where the precedences of extensions are defined by an alphanumeric order of extension names or identifiers.

15. The system of claim 12, where the precedences of extensions are defined by an assigned priority attribute of each of the multiple extensions.

16. The system of claim 12, where the precedences of extensions are defined by a user-defined order of extensions.

17. The system of claim 12, where a delta of one extension is considered in conflict with a delta of another extension if they set attributes of the network request to different values.

18. The system of claim 12, where a delta is ignored if it is in conflict with a delta of another extension with higher precedence.

19. The system of claim 12, where a delta is partially overridden by deltas of extensions with higher precedence.

20. The system of claim 12, where a delta is ignored if an extension of higher precedence created a non-empty delta.

21. The system of claim 12, where an extension is considered in conflict with another extension, if its delta is in conflict with a delta of the other extension.

22. The system of claim 12, where an extension is disabled if it is in conflict with any higher precedence extension.

23. The system of claim 12, where an extension is disabled if it is in conflict with any higher precedence extension for multiple requests.

24. The system of claim 12, where an extension is reported to a user as conflicting if it is in conflict with another extension of higher precedence.

25. The system of claim 12, where conflicting pairs of extensions are reported to a user.

26. The system of claim 1, where extensions may modify a page model of a web page.

27. A method comprising:
executing, using a processor of a computing device, multiple extensions in parallel that each attempt to modify a network request related to a webpage; and
resolving conflicts among attempts by multiple extensions to modify the network request, wherein the conflicts are resolved using a set of precedence criteria and conflict rules.

28. A computer program product, the computer program product being embodied on a non-transitory computer-readable medium and including executable code that, when executed, is configured to cause a computing device to:
execute multiple extensions in parallel that each attempt to modify a network request related to a webpage; and
resolve conflicts among attempts by the multiple extensions to modify the network request, wherein the conflicts are resolved using a set of precedence criteria and conflict rules.
